(19) United States
(12) Patent Application Publication
(10) Pub. No.: US 2023/0308137 A1
(43) Pub. Date: Sep. 28, 2023

(54) WIRELESS TELECOMMUNICATIONS NETWORK

(71) Applicant: BRITISH TELECOMMUNICATIONS PUBLIC LIMITED COMPANY, London (GB)

(72) Inventors: David TOWNEND, London (GB); Arman SHOJAEIFARD, London (GB)

(21) Appl. No.: 18/040,872

(22) PCT Filed: Jul. 26, 2021
(86) PCT No.: PCT/EP2021/070811

§ 371 Date: Feb. 7, 2023

(30) Foreign Application Priority Data
Aug. 11, 2020 (GB) 2012473.1

(51) Int. Cl. H04B 7/024; H04W 60/00; H04L 5/00

(52) U.S. Cl. CPC H04B 7/024; H04W 60/00; H04L 5/0035

(57) ABSTRACT

A method of operating an access point in a wireless telecommunications network, the access point configured to cooperate with other access points in the wireless telecommunications network to form a user-centric cluster, is disclosed. The method can include determining a master node suitability value for the access point representing the suitability of the access point to be a master node in a user-centric cluster; and transmitting the determined master node suitability value in a physical layer signal to a User Equipment (UE). A method of operating a User Equipment (UE) in a wireless telecommunications network, the wireless telecommunications network including a first access point configured to cooperate with other access points in the wireless telecommunications network to form a user-centric cluster, also is disclosed.

### PRIORITY CLAIM

The present application is a National Phase entry of PCT Application No. PCT/EP2021/070811, filed Jul. 26, 2021, which claims priority from GB Patent Application No. 2012473.1, filed Aug. 11, 2020, each of which is hereby fully incorporated herein by reference.

### TECHNICAL FIELD

The present disclosure relates to a wireless telecommunications network.

### BACKGROUND

A cellular telecommunications network is a common form of wireless telecommunications network. The cellular telecommunications network would typically include an access point (often called a base station) which would communicate with User Equipment (UE) in its coverage area (that is, the area around the access point within which the UE may receive and successfully decode the access point's transmissions). Such networks were described as “cellular” as the coverage areas of multiple access points formed a cellular structure so as to maximize overall coverage, but typically with a small portion of overlap between coverage areas of adjacent access points so that mobile UE could be handed over between access points. Spectral efficiency of such cellular telecommunications networks was limited as the same spectrum range was shared by all UE within the coverage area of each access point. Furthermore, UE positioned in the overlapping portions of coverage areas of several access points often suffered from increased levels of interference, impacting their performance.

To address these issues, it has been proposed that access points may cooperate in their communications with UE such that each UE receives transmissions from multiple access points. There have been several concepts that involve such cooperation, including network Multiple Input Multiple Output (MIMO), distributed MIMO, Cooperative Multipoint joint Processing (CoMP), Distributed Antenna Systems (DAS), and cell-free (also known as cell-less) networks. An initial step of these cooperative communication concepts is to identify the access points that will cooperate (often called “clustering”). Some cooperative communication concepts utilized network-centric clustering approaches, in which a cluster of access points were grouped together and would then cooperate in their communications with any UE positioned within a combined coverage area (being the combination of the coverage areas of each of the cluster of access points). The combined coverage area did not (or at most only partially) overlapped with the coverage areas of other access points. A benefit to this approach is that communication between access points to facilitate cooperation was only required between those access points (limiting the capital expenditure required for requisite fronthaul connections). However, this implementation suffered from poor performance at the edge of the combined coverage area, where interference was substantial.

An alternative approach was user-centric clustering in which each UE is served by a cluster of access points from which the UE may receive and successfully decode transmissions. This approach may be realized in wireless telecommunications networks having a plurality of distributed access points which may communicate with each other (i.e. over a fronthaul connection) via a centralized controller (e.g. Central Processing Unit (CPU)), such as a distributed massive MIMO system based on a Cloud Radio Access Network (C-RAN) architecture. These user-centric clustering approaches required a process to identify the access points that will become members of the cluster of access points for each UE, an example of which builds upon the cell selection process of traditional cellular networks. Initially, therefore, the process to identify the cluster of access points for a UE involves the UE identifying a single access point in the network having the greatest signal strength (i.e. Signal-to-Noise Ratio (SNR)) for its downlink pilots. The UE then sends a random access request to this access point. This access point becomes the “master” access point for the UE. The master access point then monitors all uplink pilots from the UE to identify the uplink pilot having the least pilot contamination. This uplink pilot is then assigned to that UE. The master node then sends a message to all other access points with which it can communicate (i.e. via the CPU) indicating that it will serve this UE with the assigned uplink pilot. The other access points may then independently decide whether to cooperate with the master node. This decision may be based on, for example, whether that uplink pilot is currently available (i.e. has not been assigned by that other access point for use with another UE) or, if it has been assigned for use with another UE, whether it has a better quality channel with the UE than the other UE that is currently assigned that uplink pilot. A cluster of access points is then formed for that UE consisting of the master access point and all other access points that have decided to cooperate. The membership of this cluster of access points for that UE may change over time (for example, because the UE and/or access points may be mobile) by, for example, the UE repeating the above process at a subsequent time to appoint a new master access point, or the master access point periodically re-assigning the uplink pilot and creating a new cluster of access points based on the re-assigned uplink pilot. This method of dynamically identifying a cluster of access points for a UE is sometimes referred to as dynamic cooperation clustering.

The present inventors have realized that the selection of a master node, based on the downlink pilot's SNR, is sub-optimal.

### SUMMARY

According to a first aspect of the disclosure, there is provided a method of operating an access point in a wireless telecommunications network, the access point configured to cooperate with other access points in the wireless telecommunications network to form a user-centric cluster, the method comprising determining a master node suitability value for the access point representing the suitability of the access point to be a master node in a user-centric cluster; and transmitting the determined master node suitability value in a physical layer signal to a User Equipment (UE).

The physical layer signal may be part of a UE to access point attach procedure.

The transmitting may include transmitting a plurality of beams, each including a beam identifier as a physical layer signal, in a time-domain sequence, wherein the time-domain sequence correlates to the determined master node suitability value.

The master node suitability value may be determined based on one or more of a group of access point properties comprising: a count of connections with other access points in the wireless telecommunications network, a fronthaul connection quality indicator, a backhaul connection quality indicator, a load indicator, a processing capability indicator, a pilot availability indicator, and a latency indicator.

According to a second aspect of the disclosure, there is provided a method of operating a User Equipment (UE) in a wireless telecommunications network, the wireless telecommunications network including a first access point configured to cooperate with other access points in the wireless telecommunications network to form a user-centric cluster, the method comprising receiving a first physical layer signal from the first access point; processing the first physical layer signal to determine a master node suitability value for the first access point representing the suitability of the first access point to be a master node in a first user-centric cluster; and based on the master node suitability value for the first access point, sending an attach request message to the first access point.

The wireless telecommunications network may include a second access point configured to cooperate with other access points in the wireless telecommunications network to form a user-centric cluster, and the method may further comprise receiving a second physical layer signal from the second access point; processing the second physical layer signal to determine a master node suitability value for the second access point representing the suitability of the second access point to be a master node in a second user-centric cluster; and comparing the master node suitability values of the first and second access points.

According to a third aspect of the disclosure, there is provided a computer program comprising instructions which, when the program is executed by a computer, cause the computer to carry out the method of the first aspect or the second aspect of the disclosure. The computer program may be stored on a computer readable data carrier.

According to a fourth aspect of the disclosure, there is provided an access point for a wireless telecommunications network, the access point configured to cooperate with other access points in the wireless telecommunications network to form a user-centric cluster, the access point comprising a processor and a transmitter configured to cooperate to carry out the method of the first aspect of the disclosure.

According to a fifth aspect of the disclosure, there is provided a User Equipment (UE) for a wireless telecommunications network, the wireless telecommunications network having a first access point configured to cooperate with other access points in the wireless telecommunications network to form a user-centric cluster, the UE comprising a processor and a receiver configured to cooperate to carry out the method of the second aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of a wireless telecommunications network of a first embodiment of the present disclosure.

FIG. 2 is a schematic diagram of a first access point and a central processing unit of the network of FIG. 1.

FIG. 3 is a schematic diagram of a wireless telecommunications network implementing a first process of a first embodiment of a method of the present disclosure.

FIG. 4 is a flow diagram of the first process of the first embodiment of the method of the present disclosure.

FIG. 5a is a schematic diagram of a first beam sweeping pattern.

FIG. 5b is a schematic diagram of a second beam sweeping pattern.

FIG. 6 is a schematic diagram of a wireless telecommunications network implementing a second process of the first embodiment of the method of the present disclosure.

FIG. 7 is a flow diagram of the second process of the first embodiment of the method of the present disclosure.

### DETAILED DESCRIPTION

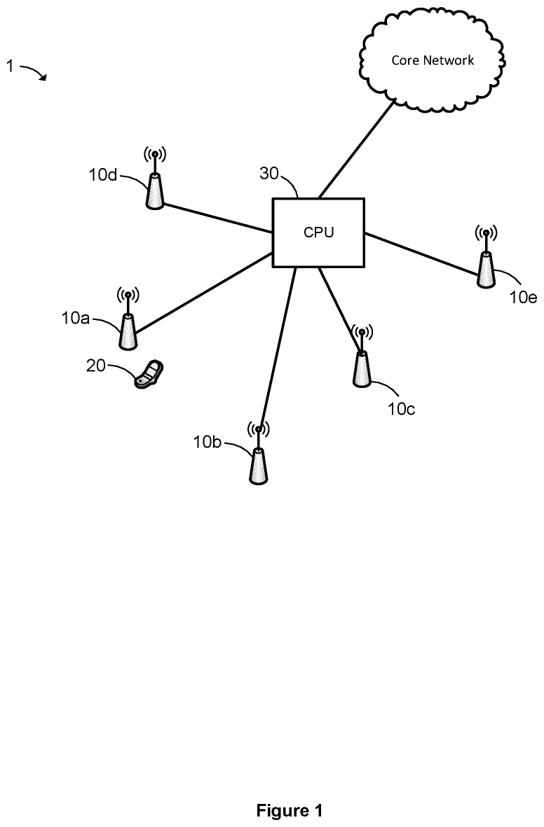

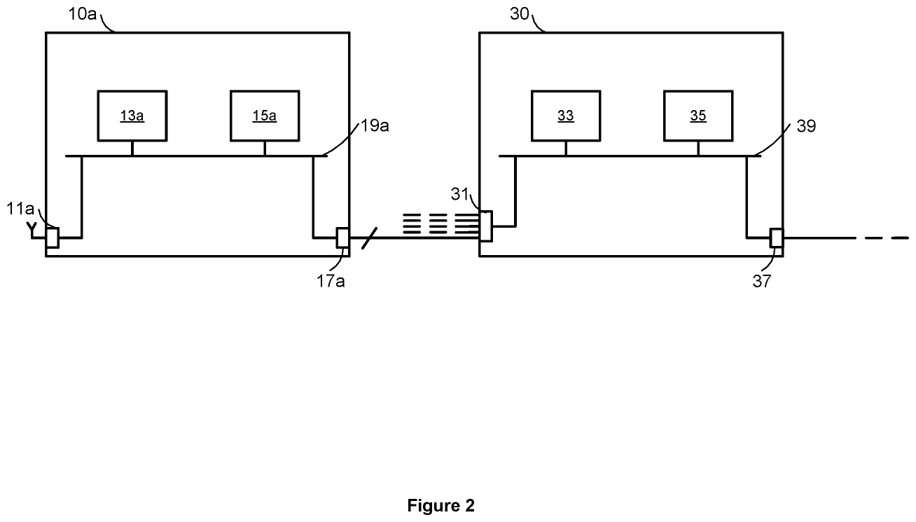

A first embodiment of a wireless telecommunications network 1 will now be described with reference to FIGS. 1 and 2. The wireless telecommunications network 1 includes a plurality of access points 10a . . . 10e, a User Equipment (UE) 20 and a Central Processing Unit (CPU) 30. In this embodiment, each access point of the plurality of access points 10a . . . 10e is connected to all other access points of the plurality of access points 10a . . . 10e via the CPU 30.

A first access point 10a of the plurality of access points 10a . . . 10e and the CPU 30 are shown in FIG. 2. The first access point 10a includes a first communications interface 11a, a processor 13a, memory 15a, and a second communications interface 17a, all connected via bus 19a. In this embodiment, the first communications interface 11a is connected to a plurality of antennas configured for communications with UE (such as UE 20) via the 5th Generation (5G) cellular networking protocol (as standardized by the 3rd Generation Partnership Project (3GPP)). The plurality of antennas are configured for beamforming and, in this embodiment, are configured to form four separate beams. In this embodiment, the second communications interface 17a is a wired (e.g. fiber optic) fronthaul connection to the CPU 30. The second, third, fourth and fifth access point 10b . . . 10e are substantially the same as the first access point 10a.

The CPU 30 is an edge-cloud processor for processing data destined for any UE connected to any one of the plurality of access points 10a . . . 10e. The CPU 30 includes a first communications interface 31, a processor 33, memory 35, and a second communications interface, all connected via bus 39. In this embodiment, the first communications interface 31 of the CPU 30 includes a wired (e.g. fiber optic) fronthaul connection to each access point of the plurality of access points 10a . . . 10e, and the second communications interface 37 is a wired (e.g. optical fiber) backhaul connection to a core network. The CPU 30 and each access point of the plurality of access points implement a Cloud-Radio Access Network (C-RAN) architecture so that their respective processors implement different elements of the communications protocol.

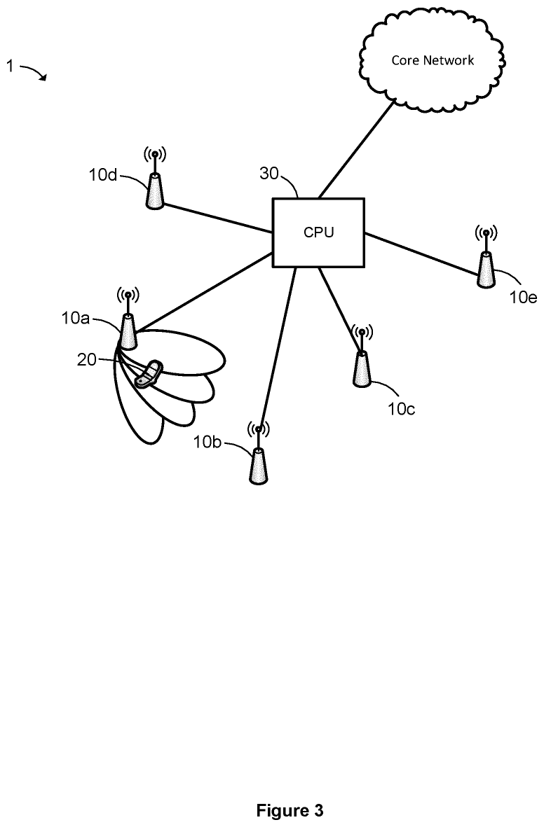

A first embodiment of a method of the present disclosure will now be described. This first embodiment includes two processes, a first process of operating an access point in the wireless telecommunications network 1 and a second process of operating a UE in the wireless telecommunications network 1. The first process will now be described from the perspective of the first access point 10a and with reference to FIGS. 3, 4, 5a and 5b. FIG. 3 illustrates a beamforming pattern of the first access point 10a, showing the coverage area of its four beams.

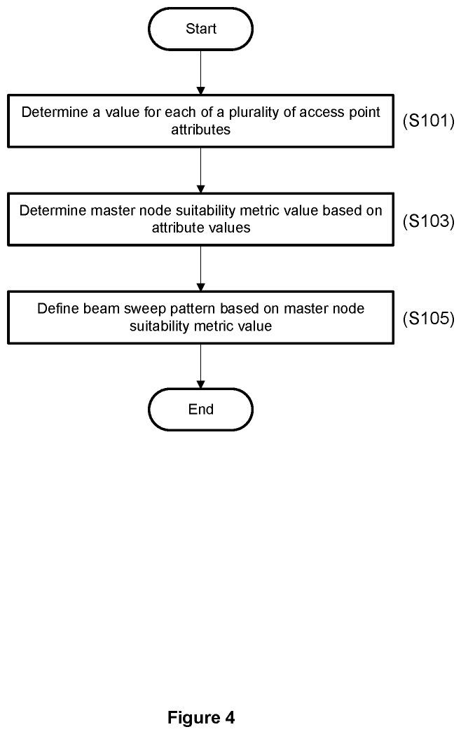

In S101 (as shown in the flow diagram of FIG. 4), the first access point 10a determines a value for each of a plurality of access point attributes, which in this embodiment includes:
A count of connections to other access points (that is, a count of access points with which the first access point 10a can communicate with via the CPU 30);
A fronthaul quality indicator for the first access point 10a representing the quality of the fronthaul connection between the first access point 10a and the CPU 30, based on, for example, bandwidth, jitter, latency, etc. The fronthaul quality indicator may be based on one or more of these properties. If based on a plurality of properties, then a weighting may be applied to different properties;
Fronthaul quality indicators for other access points (each representing the quality of the fronthaul connection between each other access point and the CPU 30) with which the first access point 10a can communicate with via the CPU 30, based on, for example, bandwidth, jitter, latency, etc. Again, the fronthaul quality indicator may be based on one or more of these properties. If based on a plurality of properties, then a weighting may be applied to different properties;
A backhaul quality indicator for the CPU 30 representing the quality of the connection between the CPU 30 and the core network;
A load indicator for the first access point representative of its current load;
A load indicator for other access points representative of the current load of other access points with which the first access point 10a can communicate via the CPU 30;
Processing capability of the first access point 10a;
An uplink pilot availability indicator, indicating the uplink pilots that the access point has available to assign and/or indicating a count of other access points for which these uplink pilots are available (and may therefore cooperate in a cluster using one of these uplink pilots); and
UE mobility, which may be, for example, an average value representative of UE mobility.

In S103, the first access point 10a determines a master node suitability metric based on one or more of these attribute values, which may be normalized. This metric may be based on a weighted combination of several attribute values, and the optimal selection of attributes and weightings may be selected and updated by the network operator. In this embodiment, the metric value is one of a set of discrete values representing the access point's suitability to be a master node for a UE, in which a higher value corresponds to the access point being more suitable as a master node, and the set size is based on the number of beams being transmitted by the first access point 10a.

In S105, the first access point 10a defines a beam sweep pattern based on its master node suitability metric value. A brief overview of the beam sweep mechanism of the first access point 10a will now be described. The first access point 10a is configured to transmit Synchronization Signal Blocks (SSBs) during a time frame known as a Synchronization Signal (SS) burst. Each SSB is associated with a particular beam of the first access point 10a, such that there are four SSBs and there is a one-to-one mapping between beams and SSBs. The SS burst is divided into as many timeslots as there are beams (in this example, four), during which only one beam (and its associated SSB) is transmitted. In an example SS burst, a first beam (having SSB index 1) is exclusively transmitted in a first timeslot of the SS burst, a second beam (having SSB index 2) is exclusively transmitted in a second timeslot of the SS burst, a third beam (having SSB index 3) is exclusively transmitted in a third timeslot of the SS burst, and a fourth beam (having SSB index 4) is exclusively transmitted in a fourth timeslot of the SS burst. A UE (such as UE 20) may then measure the signal strength of each beam in order to identify the beam having the strongest signal. The UE then determines the SSB index for that beam, and initiates a process to connect to the first access point 10a via that beam.

In this embodiment, the first access point 10a is configured to define a beam sweep pattern based on the master node suitability metric value so as to convey this value to the UE. This is achieved by modifying the order in which the first access point 10a transmits its four beams. That is, rather than always transmitting its four beams in the same order (such that the nth beam (having SSB index n) is always transmitted in the nth timeslot of the SS burst), the beams may be transmitted in one of the following orders: {1,2,3,4}, {1,2,4,3}, {1,3,2,4}, {1,3,4,2}, {1,4,2,3}, {1,4,3,2}, {2,1,3,4}, {2,1,4,3}, {2,3,1,4}, {2,3,4,1}, {2,4,1,3}, {2,4,3,1}, {3,1,2,4}, {3,1,4,2}, {3,2,1,4}, {3,2,4,1}, {3,4,1,2}, {3,4,2,1}, {4,1,2,3}, {4,1,3,2}, {4,2,1,3}, {4,2,3,1}, {4,3,1,2}, or {4,3,2,1}, wherein the number represents the beam and associated SSB index, and the position in the sequence represents the timeslot in which that beam is transmitted. Each order is associated with a corresponding master node suitability value being one of a set from 1 to 24, such that master node suitability value 1 is associated with beam sweep pattern {1,2,3,4}, master node suitability metric value 2 is associated with beam sweep pattern {1,2,4,3}, and so on. The correlation between the master node suitability value and these beam sweep patterns are stored in memory in both the first access point 10a and UE 20 (so that the first access point 10a may convey its master node suitability value to the UE 20 and so that the UE 20 may decode the master node suitability value of the first access point 10a from the beam sweep pattern—described in more detail in the second process of this embodiment).

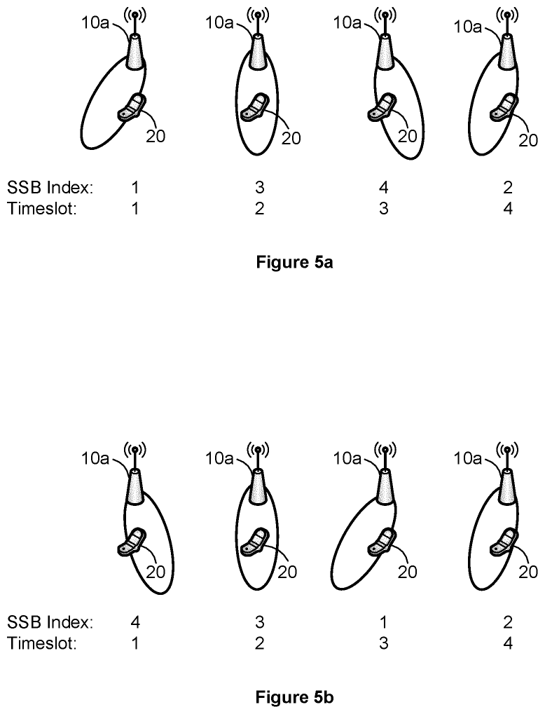

Two example beam sweep patterns will now be described and illustrated in FIGS. 5a and 5b. In a first example as shown in FIG. 5a, the master node suitability value for the first access point 10a is 4, corresponding to beam sweep pattern {1,3,4,2}, so that the first beam (having SSB index 1) is transmitted in the first timeslot of the SS burst, the third beam (having SSB index 3) is transmitted in the second timeslot of the SS burst, the fourth beam (having SSB index 4) is transmitted in the third timeslot of the SS burst, and the second beam (having SSB index 2) is transmitted in the fourth timeslot of the SS burst. In a second example as shown in FIG. 5b, the master node suitability for the first access point 10a is 23, corresponding to beam sweep pattern {4,3,1,2}, so that the fourth beam (having SSB index 4) is transmitted in the first timeslot of the SS burst, the third beam (having SSB index 3) is transmitted in the second timeslot of the SS burst, the first beam (having SSB index 1) is transmitted in the third timeslot of the SS burst, and the second beam (having SSB index 2) is transmitted in the fourth timeslot of the SS burst.

The above process is repeated periodically so as to determine updated values for each of the plurality of access point attributes and determine whether the master node suitability value has changed based on these updated values. Accordingly, the first access point 10a receives data from other access points of the plurality of access points 10a . . . 10e in order to update certain attribute values that are relevant to those other access points (e.g. fronthaul quality indicator for other access points), which may be via request/response messaging or periodic update messaging. If the master node suitability value changes, then the first access point 10a reconfigures the beam sweep pattern based on the new master node suitability value.

Although described from the perspective of the first access point 10a, this first process may be implemented by several (or all) of the access points of the first plurality of access points 10a . . . 10e. Accordingly, each access point may retrieve data for other access points for any attribute that relates to other access points, determine its own master node suitability value, and broadcast this master node suitability value in a beam sweep pattern.

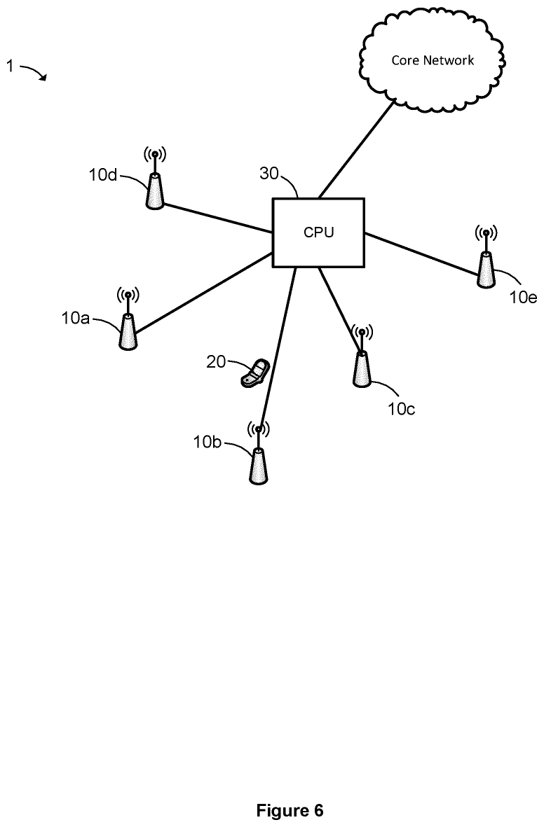

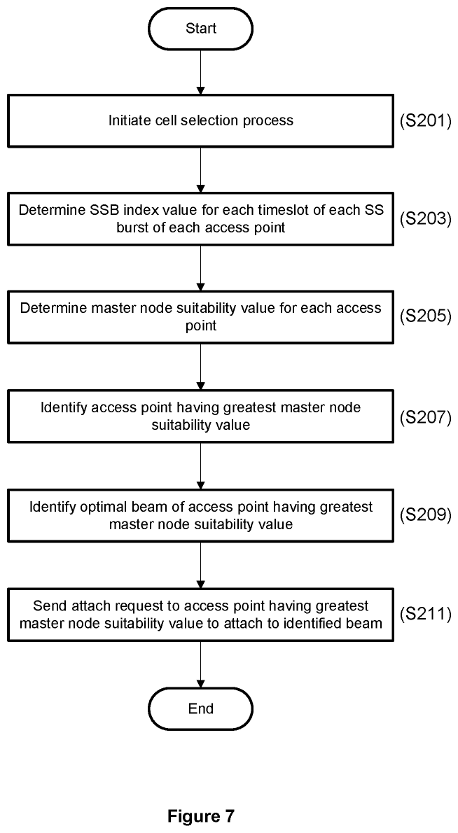

A second process of this first embodiment will now be described with reference to FIGS. 6 and 7. FIG. 6 illustrates the wireless telecommunications network, including the plurality of access points 10a . . . 10e and the UE 20 (the beamforming patterns of each access point are not shown).

This second process is implemented by the UE 20 and allows the UE 20 to determine the master node suitability value for any access point implementing the first process above, and use this master node suitability value to select one of the plurality of access points 10a . . . 10e as its master node. It is further noted that, in this example, the plurality of access points 10a . . . 10e have the following master node suitability values and beam sweep patterns:

| Access Point | Master Node Suitability Value | Beam Sweep Pattern |
|---|---|---|
| 10a | 3 | {1, 3, 2, 4} |
| 10b | 19 | {4, 1, 2, 3} |
| 10c | 16 | {3, 2, 4, 1} |
| 10d | 15 | {3, 2, 1, 4} |
| 10e | 7 | {2, 1, 3, 4} |

In S201, as shown in the flow diagram of FIG. 7, the UE 20 is powered on and initiates a cell selection process. In this example, the UE 20 is positioned within the respective coverage areas of the first access point 10a, second access point 10b and third access point 10c, such that it receives the SSBs transmitted by each of the first access point 10a, second access point 10b and third access point 10c for their respective beams. The UE 20 may differentiate between the access points based on the Physical Cell Identifier (PCI) value (decoded from the synchronization signals within the SSBs) and between the beams of each access point based on the SSB index value. In [[step]] S203, the UE 20 monitors the SS burst of each access point to determine the SSB index in each timeslot to determine the beam sweep pattern of each access point. These beam sweep patterns are stored in memory, alongside an identifier (i.e. PCI) for the access point transmitting the beam sweep pattern. In this example, this data includes: PCI(10a): {1,3,2,4}, PCI(10b): {4,1,2,3}, PCI(10c): {3,2,4,1}.

In S205, the UE 20 determines the master node suitability value of each access point detected in S203 based on a matching operation between the detected beam sweep patterns and a reference table stored in memory (associating each beam sweep pattern with a master node suitability value). In S207, the UE 20 identifies the access point having the greatest master node suitability value, which in this example is the second access point 10b.

In S209, the UE 20 identifies an optimal beam of the four beams transmitted by the second access point 10b (e.g. based on each beam's signal strength). In S211, the UE 20 sends a request to the second access point 10b to attach to the identified beam.

Once attached, the second access point 10b is the master node access point for the UE 20. The second access point 10b may therefore implement one or more of the following master node functions:
Assign an uplink pilot for communications with the UE 20 based on measurements of the uplink pilots transmitted by the UE 20,
Communicate with other access points of the plurality of access points to request cooperation in serving the UE 20 as cluster using the assigned uplink pilot, and
Distribute control signals between all cooperating access points in the cluster.

This embodiment therefore provides an improved method for UEs to attach to access points based on the access point's suitability to act as a master node. This is achieved by the access point broadcasting its suitability to act as a master node via a physical layer broadcast, so that UEs may determine the access point's master node suitability value without having to access the network.

Although the second process above is triggered following the UE switching to a powered state and initiating a cell selection process, the skilled person will understand that there may be other triggers for the UE to select a new master node. This may occur, for example, when the UE is already associated (either in an idle mode or a connected mode) with a master node, but the connection quality to the master node degrades below a threshold.

The above embodiment uses the beam sweep pattern to convey the master node suitability value to the UE based on a time-domain sequence. In another implementation utilizing the beam sweep pattern, a binary metric value (i.e. indicating whether the access point is either suitable or not suitable as a master node) may be conveyed to the UE by the beam index increases with increasing timeslot in the SS burst or the beam index decreases with increasing timeslot in the SS burst.

Furthermore, the master node suitability metric value may be conveyed to the UE through other messages that are transmitted to the UE prior to an attach request from the UE, such as any other part of the SSB. In other words, the value may be conveyed to the UE through any other physical layer transmission. For example, the PCI value (or a part thereof, such as the value of the primary or secondary synchronization signal) may be used such that a PCI value within a particular range correlates to a particular master node suitability value.

Furthermore, it is non-essential that the UE 20 implements a comparison between master node suitability values for several access points in order to benefit from the present invention. That is, the UE 20 may have a minimum threshold master node suitability value, and the UE 20 may only attach to a beam of an access point having a master node suitability value above this minimum threshold.

The above embodiment is based on a wireless telecommunications network in which the access points cooperate to serve UE by user-centric clustering (such as dynamic cooperation clustering). Such networks may be known as network MIMO, personal cell networks, cell-free networks or cell-less networks. The skilled person will understand that it is non-essential for the wireless telecommunications network to be solely based on this architecture, such that a hybrid architecture with a cellular telecommunications network may be used.

The skilled person will also understand that the list of attributes that are used in the master node suitability metric calculation is non-essential, and a network operator may define the particular set of attributes and their weighting. Furthermore, the UE mobility attribute is not typically known to the access point prior to attachment, but can be based on averages or may be predicted based on historical data.

It is also non-essential that the access point self-determine its master node suitability value. A central controller, such as the CPU 30, may determine its value (or respective values for a plurality of access points) and inform the access point of that value.

In the above embodiment, each access point transmitted four beams. Furthermore, each access point and the UE had a table mapping between a beam sweep pattern for four beams and the corresponding master node suitability value. The skilled person will realize that access points may have a different number of beams, such as eight beams. Each possible beam sweep pattern for those eight beams may correlate with a particular master node suitability value, and each access point and the UE may also have a table mapping between the beam sweep pattern for eight beams and the corresponding master node suitability value. The master node suitability values may therefore be normalized between 0 and 1, so that the values retrieved from tables for different numbers of beams are comparable. Accordingly, in an implementation where a first access point has four beams and a second access point has eight beams, the UE may determine the number of beams for each access point based on the number of unique beams transmitted by that access point (e.g. having the same PCI value), and then perform a matching operation on the beam sweep pattern for the four beams of the first access point and a matching operation on the beam sweep pattern for the eight beams of the second access point with corresponding tables (mapping between master node suitability values and beam sweep patterns) for four or eight beams respectively.

The skilled person will understand that any combination of features is possible, within the scope of the disclosure, as claimed.

1. A method of operating an access point in a wireless telecommunications network, the access point configured to cooperate with other access points in the wireless telecommunications network to serve as a user-centric cluster, the method comprising:
determining a master node suitability value for the access point representing a suitability of the access point to be a master node in a user-centric cluster; and
transmitting the determined master node suitability value in a physical layer signal to a User Equipment (UE).

2. The method as claimed in claim 1, wherein the physical layer signal is part of a UE to access point attach procedure.

3. The method as claimed in claim 1, wherein the transmitting includes:
transmitting a plurality of beams each including a beam identifier as a physical layer signal, in a time-domain sequence, wherein the time-domain sequence correlates to the determined master node suitability value.

4. The method as claimed in claim 1, wherein the master node suitability value is determined based on one or more of a group of access point properties consisting of:
a count of connections with other access points in the wireless telecommunications network,
a fronthaul connection quality indicator,
a backhaul connection quality indicator,
a load indicator,
a processing capability indicator,
a pilot availability indicator, and
a latency indicator.

5. A method of operating a User Equipment (UE) in a wireless telecommunications network, the wireless telecommunications network including a first access point configured to cooperate with other access points in the wireless telecommunications network to serve as a user-centric cluster, the method comprising:
receiving a first physical layer signal from the first access point;
processing the first physical layer signal to determine a master node suitability value for the first access point representing a suitability of the first access point to be a master node in a first user-centric cluster; and
based on the master node suitability value for the first access point, sending an attach request message to the first access point.

6. The method as claimed in claim 5, wherein the wireless telecommunications network includes a second access point configured to cooperate with the other access points in the wireless telecommunications network to form the user-centric cluster, the method further comprising:
receiving a second physical layer signal from the second access point;
processing the second physical layer signal to determine a master node suitability value for the second access point representing a suitability of the second access point to be a master node in a second user-centric cluster; and
comparing the master node suitability values of the first access point and the second access point.

7. The method as claimed in either claim 5, wherein the physical layer signal is part of a UE to access point attach procedure.

8. A non-transitory computer-readable storage medium storing a computer program comprising instructions which, when executed by a computer, cause the computer to carry out the method of claim 1.

9. A system comprising:
at least one processor and memory configured to operate an access point in a wireless telecommunications network, the access point configured to cooperate with other access points in the wireless telecommunications network to serve as a user-centric cluster, by:
determining a master node suitability value for the access point representing a suitability of the access point to be a master node in a user-centric cluster; and
transmitting the determined master node suitability value in a physical layer signal to a User Equipment (UE).

10. An access point for a wireless telecommunications network, the access point configured to cooperate with other access points in the wireless telecommunications network to form a user-centric cluster, the access point comprising a processor and a transmitter configured to cooperate to carry out the method of claim 1.

11. A User Equipment (UE) for a wireless telecommunications network, the wireless telecommunications network having a first access point configured to cooperate with other access points in the wireless telecommunications network to form a user-centric cluster, the UE comprising a processor and a receiver configured to cooperate to carry out the method of claim 5.
